(19) United States
(12) Patent Application Publication
(10) Pub. No.: US 2016/0146472 A1
(43) Pub. Date: May 26, 2016

(54) COOKING APPLIANCE COMPONENT AND METHOD FOR PRODUCING A COOKING APPLIANCE COMPONENT

(71) Applicant: Miele & Cie. KG, Guetersloh (DE)

(72) Inventors: Karl Wiengarten, Beelen (DE); Joerg Neumann, Schwerte (DE)

(21) Appl. No.: 14/946,816

(22) Filed: Nov. 20, 2015

(30) Foreign Application Priority Data
Nov. 26, 2014 (DE) 10 2014 117 289.2
Jul. 3, 2015 (DE) 10 2015 110 756.2

(51) Int. Cl. F24C 14/02; B05D 7/14

(52) U.S. Cl. CPC F24C 14/02; B05D 7/14

(57) ABSTRACT

A cooking appliance component includes a cooking chamber for carrying out pyrolysis and a component wall that delimits the cooking appliance component at least in part. The component wall includes a metal substrate having an enamel coating applied thereto at least in part, and at least one surface portion free of the enamel coating so as to be electrically conductive for making electrical contact with the metal substrate. The metal substrate, at least in part, is a steel that is heat-resistant and at least one of austenitic or ferritic.

### CROSS-REFERENCE TO PRIOR APPLICATION

Priority is claimed to German Patent Application No. DE 10 2014 117 289.2, filed on Nov. 26, 2014, and to German Patent Application No. DE 10 2015 110 756.2, filed on Jul. 3, 2015, the entire disclosures of which are hereby incorporated by reference herein.

### FIELD

The present invention relates to a cooking appliance component and to a method for producing a cooking appliance component of this kind, the cooking appliance component in particular comprising a cooking chamber suitable for carrying out pyrolysis and a component wall which delimits the cooking appliance component at least in part. In this case, the component wall comprises a metal substrate having an enamel coating provided thereon.

### BACKGROUND

In the prior art, a very wide range of cooking appliances are known which comprise a cooking chamber suitable for pyrolysis. Usually, the cooking chamber wall includes a black plate to which an enamel coating is applied in order to protect against corrosion. The visible surface properties of enamel-coated metallic cooking chamber walls also do not change during repeated pyrolysis at temperatures of over 400° C. The enamel coating reliably protects the surface from colour change due to tarnish or from corrosion.

DE 10 2012 109147 describes a domestic appliance in which a component comprises an enamel layer and a conductive coating arranged thereon.

It becomes more difficult when bare metal surface regions are desired for decorative purposes of for technical reasons. If black plate is used, it would rapidly corrode on account of the water vapour present inside the cooking chamber and outside the cooking chamber, and the technical and surface properties thereof would change. If stainless steel is used, pyrolysis should not be carried out because visually unattractive tarnish appears on the stainless steel surface in the event of repeated heating to pyrolysis temperatures. Applying a thin glass layer to visible metallic surfaces is a measure for protecting against tarnishing, but as a result electrical contact is no longer possible, since the additional glass layer has an electrically insulating effect.

### SUMMARY

In an embodiment, a cooking appliance component includes a cooking chamber for carrying out pyrolysis and a component wall that delimits the cooking appliance component at least in part. The component wall includes a metal substrate having an enamel coating applied thereto at least in part, and at least one surface portion free of the enamel coating so as to be electrically conductive for making electrical contact with the metal substrate. The metal substrate, at least in part, is a steel that is heat-resistant and at least one of austenitic or ferritic.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic front view of a cooking appliance according to the invention; and

FIG. 2 is a highly schematic and enlarged cross section through a portion of the cooking chamber wall.

### DETAILED DESCRIPTION

A cooking appliance component according to the invention in particular comprises a cooking chamber suitable for carrying out pyrolysis, the cooking appliance component comprising at least one component wall which delimits the cooking appliance component at least in part. The component wall comprises a metal substrate having an enamel coating applied thereto at least in part. The cooking chamber wall comprises at least one surface portion which is kept free of the enamel coating and is therefore electrically conductive for making electrical contact with the metal substrate, and the metal substrate comprises at least in part a steel which is heat-resistant and also austenitic or ferritic.

The cooking appliance component according to the invention has a number of advantages. A significant advantage of the cooking appliance component according to the invention is that the cooking appliance component is designed to be capable of pyrolysis, and at the same time comprises an electrically conductive surface portion for making electrical contact with the metal substrate. As a result, more technical and also decorative design options are available.

In simple cases, a cooking appliance component according to the invention can be formed as a baking muffle. It is also possible and preferred to design the cooking appliance component as a cooking appliance on which at least one baking muffle capable of pyrolysis is provided. In particularly preferred embodiments, the cooking appliance component is in principle capable of microwave or high-frequency operation. In applications of this kind, high-frequency radiation such as microwaves or similar is introduced into the interior of the cooking chamber in order to heat the food in the interior of the cooking chamber using radiation energy at least in part. In applications of this kind, electrical contact with the cooking chamber wall is usually necessary in order to achieve reliable shielding. High-frequency radiation should be prevented from escaping from the interior of the cooking chamber. For this purpose, it is expedient to protect the entire cooking chamber against the escape of high-frequency radiation. However, the cooking appliance component can also be designed as a container or as another functional part of a cooking appliance, for example as a steam generator.

In order for protection of this kind to be reliably and permanently maintained, even when carrying out pyrolysis processes, it is very advantageous to use an austenitic or ferritic heat-resistant steel, in which an electrically conductive surface portion for making electrical contact with the metal substrate also remains permanently free of oxide layers and the like.

Particularly preferably, austenitic or ferritic heat-resistant steels are used which do not corrode even at the temperatures of up to 860° C. or possibly 880° C. or more which occur when coating with enamel, meaning that no or only very little reworking of the surface of the substrate is required. As a result, an enamel-free surface portion can be produced directly on the cooking chamber wall at the same time as the enamel layer is applied, in that the desired surface portion is for example appropriately covered or masked off prior to the enamel layer being applied, in order to provide a bare metal surface portion there. By means of measures of this kind and using the austenitic or ferritic heat-resistant steels mentioned, it is possible to provide the substrate for the cooking chamber wall with a complete enamel layer, leaving free the at least one electrically conductive surface portion. No or only very little impairment of the electrical conductivity of the electrically conductive surface portion occurs in the process. Here, a low impact on the electrical conductivity is preferably understood, within the context of the present invention, as being at most a four-fold increase in the electrical resistance and in particular at most a two-fold or 1.5-fold increase in the electrical contact resistance at the electrically conductive surface portion.

In particularly preferred developments and embodiments, the metal substrate comprises at least in part a steel which is heat-resistant according to norm DIN EN 10095. Particularly preferably, the metal substrate is comprised entirely of a steel of this kind. Here, the metal substrate is understood in particular as the muffle wall or the steel wall of the cooking chamber.

In this case, the steel is in particular a special steel and preferably a stainless steel. It is possible to use ferritic heat-resistant steels having the material number and material short form designation 1.4742, 1.4762 and optionally 1.4724 and 1.4713. Austenitic heat-resistant steels having the short forms 1.4878 and 1.4828 and 1.4821, as well as 1.4876 and 1.4872 and 1.4835 are possible and particularly preferred. The use of an austenitic heat-resistant steel from the group 1.4841 has been found to be advantageous. Steels from the group 1.4841 are heat-resistant up to 1120° C. in air and comprise components of carbon, chromium, nickel, silicon and optionally aluminium.

Particularly preferably, the metal substrate comprises a surface which is roughened at least in part and in particular completely. An embodiment of this kind is particularly advantageous since stainless steels, as mentioned above, and also other stainless steels have reduced adhesion between the steel and an enamel layer. It is possible to apply an additional adhesion-promoting layer to the substrate prior to applying an enamel layer, but as a result the electrical contact with the metal substrate is usually prevented or at least significantly impeded. This means that a labour-intensive reworking step must then be carried out after applying the enamel layer in order to permit electrical contact with the metal substrate and in order to provide said contact at a quality adequate for the intended applications.

It has now been found, surprisingly, that a roughened surface of the metal substrate permits significantly improved and adequate adhesion of the enamel layer on the high-alloy special steel of the metal substrate. If roughening of this kind is carried out using a grain size of 80 for example, reasonable and adequate adhesion can be achieved.

Particularly preferably, the surface of the metal substrate is roughened at least in part by means of brushing. It is also possible to roughen the surface of the metal substrate at least in part by means of grinding or sandblasting for example. It is also possible to use 2 or 3 different methods for producing the roughened surface. Brushing has been found to be particularly advantageous, since an inherently low-tension and roughened surface of the metal substrate can be provided thereby in a reliable and reproducible manner. If a sandblasting process is used this can lead to local thickening of the surface, which can then lead to undesirable curved or bent surfaces if the parameters of the sandblasting procedure are unfavourably selected.

Particularly preferably, the surface of the metal substrate is roughened on both sides. This is preferable for various reasons, and also because tensions may occur in the metal substrate on account of possibly occurring tensions due to the “bi-metallic effect”.

Certain parameters for the surface of the metal substrate have been found to be particularly suitable. In particular, a mean roughness value Ra of between approximately 1 μm and 4 μm is preferred. Mean roughness values of between 2 μm and 3 μm are particularly advantageous. Here, the mean roughness value is understood as being the arithmetic mean roughness value.

Particularly preferably, the surface of the metal substrate has a roughness depth Rz of between approximately 10 μm and 40 μm. Advantageously, the roughness depth Rz is of between approximately 15 μm and 25 μm. Here, the roughness depth is understood as being the mean roughness depth, and not exactly the depth of individual grooves or points or grooves on the surface of the metal substrate.

Particularly preferably, the metal substrate has at least one sandblasted weld seam. Preferably, the metal substrate is bent to form a cooking chamber muffle or the like, and the two ends are welded together at the joining edge in order to provide a completely closed baking muffle or the like. It is also possible and preferred to brush the weld seam in order to achieve the desired surface precision there. However, in the region of the weld seam it may be more cost-effective and/or simpler to carry out (local) sandblasting.

Particularly preferably, the metal substrate has at least one enamel-free surface portion.

In particularly preferred embodiments, the metal substrate is coated with 2 enamel layers applied one on top of the other, which are in particular separately fired. However, it is also possible to apply 2 enamel layers successively and to fire them together in one firing procedure.

Applying a first enamel layer to the metal substrate and subsequently firing the first enamel layer makes it possible, for example, to select the additives and mixing ratios in the first enamel slip layer so as to be different from those in the second enamel slip layer, which is applied to the already fully fired first enamel layer. As a result, it is possible to react appropriately to the different substrates for the first enamel layer and the second enamel layer. In the case of the first enamel layer, the surface is the bare and roughened metal substrate, whereas the second enamel layer is applied to an already existing enamel layer, meaning that the adhesion conditions for the respective enamel layers are fundamentally different.

The method according to the invention is used for producing a cooking appliance component, in particular having a cooking chamber suitable for carrying out pyrolysis, a component wall, which forms the cooking appliance component at least in part, being manufactured from a metal substrate to which an enamel coating is applied at least in part. In this case, an austenitic or ferritic heat-resistant steel is used for the metal substrate at least in part, and the enamel coating is applied in such a way that at least one electrically conductive surface portion for making electrical contact with the metal substrate remains on the component wall.

The method according to the invention also has several advantages, since it permits cost-effective and simple production of a cooking appliance component according to the invention. In this case, during production, an electrically conductive surface portion for making electrical contact with the metal substrate is simultaneously produced directly on the component wall. A labour-intensive reworking step is not required in order to make electrical contact with the component wall.

Preferably, the metal substrate is roughened at least in portions and in particular substantially completely and particularly preferably completely before the enamel coating is applied. This permits improved adhesion of the enamel coating to the metal substrate, with the result that adhesion of the enamel coating to the metal substrate is also permanently and reliably ensured. In the event of repeated pyrolysis procedures and the thermal tensions occurring in the process due to the heating and expansion of the metal substrate, too weak an adhesion could lead to undesired detachment of the enamel layer and thus to destruction of the cooking appliance component. Reliable adhesion at the high thermal loads occurring during operation is therefore very important.

Particularly preferably, at least 2 enamel layers are applied, specifically first a base enamel layer and then a covering enamel layer. In this case, it is possible to first apply a base enamel layer, which is fired after the layer is applied. After firing and appropriate cooling of the metal substrate, the covering enamel layer is applied and fired in a separate firing procedure.

In other embodiments, it is also possible to apply the base enamel layer and the covering enamel layer one after the other, but to fire said layers in a common firing procedure.

Particularly preferably, a significantly lower grain fineness is used for the base enamel layer than for the covering enamel layer. Preferably, a grain-size distribution is used for the base enamel slip which has a grinding fineness of from 4-6 when tested using the 16,900 M/cm2 Bayer sieve. The fine-grained fraction of the base enamel slip, up to a size of 5 μm, should be from 15-30%, and in particular between 20 and 25%. The fine-grained fraction, up to an enamel particle size of up to 50 μm or 60 μm in diameter, should be at least 90%. An enamel slip layer having coarser enamel particles can be used for the covering enamel layer. Here, it is possible to have a grain-size distribution which has a grinding fineness of from 20-25 or similar when tested using the 16,900 M/cm2 Bayer sieve. A different grain fineness is also possible for the covering enamel layer.

Particularly preferably, a separate enamel slip layer is first applied for each enamel layer, which slip layer is subsequently fired, in particular separately. Firing temperatures of from 780° C. to 835° C. are preferred for the base enamel layer. Particularly preferably, temperatures of between 800° C. and 830° C. are used. Firing temperatures of from 840° C. to 850° C. can be used in the firing procedure for the covering enamel layer.

In particularly preferred embodiments, the enamel slip layer for the base enamel layer is thinner than the enamel slip layer for the covering enamel layer. It is likewise preferred for the base enamel layer to have a lower thickness than the covering enamel layer. The application preferably takes place in such a way that a ratio of a layer thickness of the covering enamel layer to the layer thickness of the base enamel layer is between 0.75 and 2 and in particular between 1 and 1.5.

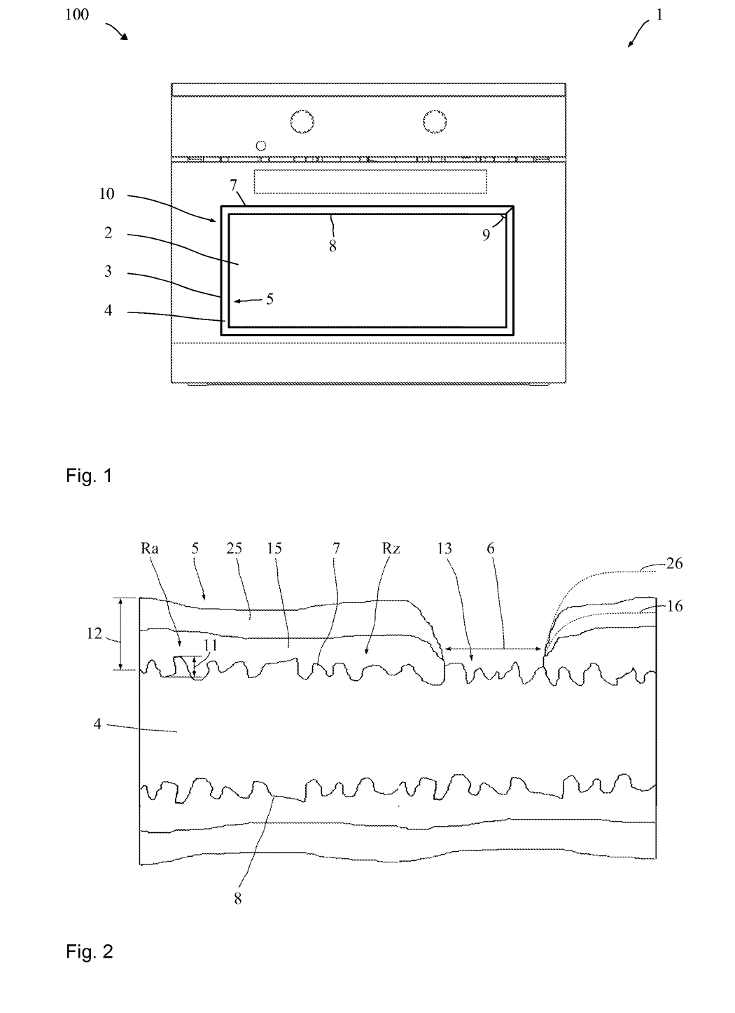

FIG. 1 is a highly schematic front view of a cooking appliance component 1, which is designed overall here as a cooking appliance 100 and comprises a baking muffle 10. It is also possible for the cooking appliance component 1 to comprise only the baking muffle 10 or only a component wall 3 or a container or a further functional part of a cooking appliance or to be formed as such. In the embodiment shown, the component wall 3 is formed by a cooking chamber wall, which is provided in the following with the same reference numeral 3.

The cooking appliance 100 comprises a cooking chamber 2 which is provided by the baking muffle 10 and is delimited laterally and at the rear by a cooking chamber wall 3. A door is provided at the front.

The cooking chamber wall 3 comprises a metal substrate 4 to which an enamel coating 5 is applied to the surfaces 7 and 8 on the outside and the inside of the cooking chamber 2.

The cooking chamber wall 3 is produced from an originally flat metal substrate 4, which is reshaped in order to form the cooking chamber. A weld seam 9 is provided at the joining edges at the ends, in order to provide a completely sealed cooking chamber 2. The weld seam 9 is shown here in a corner of the cooking chamber 2, but can in principle be provided at any desired point on the cooking chamber 2.

FIG. 2 is a greatly enlarged cross section of a portion of the cooking chamber wall 3. The metal substrate 4 is shown schematically in the cross section. Both the outer surface 7 and the inner surface 8 of the metal substrate 4 are covered with an enamel layer here, which has a thickness 12. It is also possible for the surface 7 to form the inner surface of the cooking appliance component 1 and for the surface 8 to be arranged on the outside of the cooking chamber 2.

In the enlarged schematic cross section shown in FIG. 2, the enamel-free surface portion 13 is shown on the surface portion 6 where no enamel layer 5 is provided on the metal substrate 4. In the surface portion 6, the metallic surface of the metal substrate 4 is directly accessible. As a result, an electrically conductive connection with the metal substrate 4 and thus with the cooking chamber wall 3 is possible, in order to provide electrical shielding.

The cooking substrate 4 has a rough surface, which was produced here by brushing the originally substantially smooth surface of the metal substrate. It is also possible to roughen the surfaces 7 and/or 8 of the metal substrate 4 by means of grinding or needle punching, or optionally sandblasting, in order to thus provide reasonable and adequate surface roughness of at least one surface 7, 8 of the metal substrate.

Preferably, both surfaces 7 and 8 are roughened in essentially the same manner and, with the exception of at least one surface portion 6, are substantially completely covered with the enamel layer 5. As a result an electrically conductive connection with the cooking chamber wall 3 is made possible, in order to reliably prevent high-frequency radiation such as microwave radiation or the like from escaping from the cooking chamber 2.

The metal substrate 4 comprises an austenitic or ferritic heat-resistant steel. It is possible for the cooking chamber wall to be formed of a plurality of substrate parts, although in that case at least one metal substrate comprises a heat-resistant austenitic or ferritic steel of this kind. In this case, on the metal substrate on which an electrically conductive surface portion is provided and formed, said metal substrate is produced from an austenitic or ferritic heat-resistant steel. Particularly preferably, a steel of material class 1.4841 is used, which is reliably protected from corrosion both at the high temperatures for laying the enamel layer and at the later pyrolysis-level operating temperatures. A permanent reliable electrically conductive connection to the cooking chamber wall 3 can be made possible thereby.

The originally smooth metal substrate is preferably roughened on both sides in order to prevent tensions on account of different surface treatments of each side.

The surfaces 7 and 18 are particularly preferably roughened so as to achieve an arithmetic mean roughness Ra of between 2 μm and 3 μm. Particularly preferably, at least one surface 7, 8 of the metal substrate 4 has a roughness depth Rz of between approximately 15 μm and 25 μm, and particularly preferably approximately 20 μm.

The mean roughness preferably corresponds to the arithmetic mean of the deviation of the spacing of the surface points from the centreline. In a one-dimensional extension, the mean roughness would give the height of the rectangle having the same length as the section to be analysed and the same area as the area between the reference height and the profile. The mean roughness depth is determined in a corresponding manner using known methods.

The depth 11 of individual grooves or points therefore generally does not correspond to the mean roughness or the mean roughness depth, but rather a statistical analysis is carried out.

For the purpose of producing the cooking appliance component 1, the originally smooth metal substrate 4 produced from the austenitic or ferritic heat-resistant steel is first roughened, preferably on both sides, on the surfaces 7, 8 by means of brushing or the like. Subsequently, following a cleaning step which may optionally be carried out, a first enamel slip layer 16 is applied, which is indicated only schematically by dashed lines in FIG. 2.

A density of the enamel slip layer 16 of between preferably 1.62 and 1.68 g/cm3 is set for the enamel slip layer 16. A fine grain-size distribution is used in the enamel slip layer which has a grinding fineness of from 4-6 when tested using the 16,900 M/cm2 Bayer sieve. In this case, the fine-grained fraction, up to a size of 5 μm, is between 20 and 25%, and the overall fraction of enamel particles up to a diameter of 50 μm is at least 90%. After DI water (deionised water) is added, the usual grinding, control and slip auxiliary agents are adjusted and the enamel slip layer 16 is applied to the surface 7 of the metal substrate 4 here. Prior to this, the surface portion 6 is preferably covered or masked off so that said surface portion 6 is not provided with an enamel coating.

Subsequently, the enamel slip layer 16 is dried at temperatures of between 20 and 80° C. until the residual moisture content of the enamel cake after drying is less than 4%, in particular less than 2%. Subsequently, the covering for the surface portion 6 can be removed, and the first or inner enamel layer 15 is burned in, which layer preferably has a layer thickness of between 60 and 120 μm and preferably of between 80 and 100 μm in the finished state. The enamel layer is preferably burned in at temperatures of at most 830°. Burning in preferably occurs at a lower rate and with adjusted heating and cooling in order to achieve the desired adhesive conditions.

Subsequently, the second or outer enamel slip layer 26, which is shown likewise schematically by means of dashed lines in FIG. 2, can be applied to the now finished enamel layer 15, the surface portion 6 again being left free. The enamel slip layer 26 can be applied at conventional densities of between approximately 1.7 and 1.82 g/cm3, the grain-size distribution of the base enamel slip having a grinding fineness of for example from 20-25 when measured using a 16,900 M/cm2 Bayer sieve.

The second enamel layer 25 can be burned in and dried in a substantially conventional manner, since the adhesion to the first enamel layer 15 meets the typical requirements.

Overall, the invention provides an advantageous cooking appliance component 1, in which an austenitic or ferritic heat-resistant steel is used for the metal substrate 4, and the metal substrate being substantially coated with at least one enamel coating. In the process, at least one surface portion remains free and can be contacted in an electrically conductive manner and without any particular reworking. In order to achieve the necessary adhesion, the surface of the metal substrate 4 is roughened in a defined manner, a grain size of 80 having been found to be advantageous. By contrast, roughening having too coarse or too fine a grain size has not led to the desired results.

In the present invention, it is not necessary to apply a separate, for example nickel-based, adhesion promoter. The surface of the austenitic or ferritic heat-resistant steel is roughened directly and a first enamel layer and then a second enamel layer is directly applied thereto.

The invention makes it possible to provide pyrolysis devices which have bare metal surfaces in order to make electrical contact with the cooking chamber wall or to achieve appropriate visual properties.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Cooking appliance component
2 Cooking chamber
3 Component wall
4 Metal substrate
5 Enamel coating
6 Surface portion
7 Surface
8 Surface
9 Weld seam
10 Baking muffle
11 Depth
12 Thickness
13 Enamel-free surface portion
15 (Inner) enamel layer
16 Enamel slip layer
25 (Outer) enamel layer
26 Enamel slip layer
100 Cooking appliance
Ra Mean roughness value
Rz Mean roughness depth

What is claimed is:

1. A cooking appliance component, comprising:
a cooking chamber configured to carry out pyrolysis; and
a component wall that delimits the cooking appliance component at least in part, the component wall comprising a metal substrate having an enamel coating applied thereto at least in part and having at least one surface portion free of the enamel coating so as to be electrically conductive for making electrical contact with the metal substrate,
wherein the metal substrate comprises at least in part a steel that is heat-resistant and at least one of austenitic or ferritic.

2. The cooking appliance component of claim 1, wherein the metal substrate comprises a steel that is heat-resistant according to the DIN EN 10095 standard.

3. The cooking appliance component of claim 1, wherein the metal substrate has a roughened surface.

4. The cooking appliance component of claim 3, wherein the roughened surface of the metal substrate is roughened by sandblasting, grinding, or brushing.

5. The cooking appliance component of claim 4, wherein the metal substrate comprises roughened surfaces on both sides of the metal substrate.

6. The cooking appliance component of claim 3, wherein the roughened surface of the metal substrate has a mean roughness value (Ra) of between approximately 1 μm and 4 μm.

7. The cooking appliance component of claim 3, wherein the roughened surface of the metal substrate has a roughness depth (Rz) of between approximately 10 μm and 40 μm.

8. The cooking appliance component of claim 1, wherein the metal substrate comprises at least one sandblasted weld seam.

9. The cooking appliance component of claim 1, wherein the metal substrate comprises at least one enamel-free surface portion.

10. The cooking appliance component of claim 1, wherein the metal substrate is coated with two separately fired enamel layers applied one on top of the other.

11. A method for producing a cooking appliance component that includes a cooking chamber for carrying out pyrolysis and a component wall that forms the cooking appliance component at least in part, the method comprising:
providing the component wall using, at least in part, a metal substrate that is heat-resistant and at least one of austenitic or ferritic steel; and
applying an enamel coating to the metal substrate so that at least one surface portion of the metal substrate that is kept free of the enamel coating so as to be electrically conductive remains on the component wall for making electrical contact with the metal substrate.

12. The method of claim 11, further comprising roughening the metal substrate before the applying the enamel coating.

13. The method of claim 11, wherein the applying the enamel coating comprises applying at least two enamel layers.

14. The method of claim 13, wherein the applying the at least two enamel layers comprises applying a base enamel layer and then applying a covering enamel layer.

15. The method of claim 14, wherein the base enamel layer has a significantly lower grain fineness than the covering enamel layer.

16. The method of claim 14, further comprising applying a separate enamel slip layer for each of the at least two enamel layers before each of the at least two enamel layers is applied.

17. The method of claim 16, wherein each separate enamel slip layer is fired separately.

18. The method of claim 16, wherein the enamel slip layer for the base enamel layer has a lower density than the enamel slip layer for the covering enamel layer.

19. The method of claim 14, wherein a ratio of a layer thickness of the covering enamel layer to the layer thickness of the base enamel layer is between 0.75 and 2.

20. The method of claim 19, wherein a ratio of a layer thickness of the covering enamel layer to the layer thickness of the base enamel layer is between 1 and 1.5.
